(19) United States
(12) Patent Application Publication
(10) Pub. No.: US 2006/0260727 A1
(43) Pub. Date: Nov. 23, 2006

(54) Innovated structure of wheel rim assembly

(76) Inventor: Yueh Nu Chen, T Lan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/166,071

(22) Filed: Jun. 27, 2005

(30) Foreign Application Priority Data
May 11, 2005 (TW) 094115297

(51) Int. Cl. B60C 27/00; B60C 25/00

(52) U.S. Cl. 152/205; 152/396; 152/399; 152/207

(57) ABSTRACT

An innovated structure of anti-piercing and anti-explosion vehicle tire has a ring-shaped bracket device fastened on to a wheel rim, the ring-shaped bracket device consisting of a specified number of arched bracket units having juts and recessed and shaft holes on their front and rear parts, and two bracket fastening units, with its juts and recesses joined to each other, the shaft holes are aligned and joined by bolts and fastened by a fastening ring unit; the upper arched surface of the bracket unit being a fastening surface, serving to accommodate close contact with various patterns on surfaces of different wheel rims. The ring-shaped bracket device and a wheel rim are joined to form a safe tire, to enable continued safe travel to a servicing garage for servicing purpose in case the vehicle tire is broken accidentally.

### BACKGROUND OF THE INVENTION

1. Field of the Invention

The present invention relates to an innovated structure of anti-piercing and anti-explosion wheel rim, particularly to a vehicle tire that enables continued safe travel to a servicing garage for servicing the purpose in case the tire is pierced by a sharp point or a knife that may result in leaking air or tire explosion, a structure to contribute to the traffic safety of the public.

2. Description of the Prior Art

A vehicle tire is inflated with air to form tension and expand a tube to become a tire body to carry a vehicle for driving purpose. But once the tire is pierced by a sharp object, air will leak and the vehicle will not go any further. As a result, the motorist has to push the vehicle to a garage for servicing. Or, in case a vehicle tire is destroyed during high-speed driving, it may result in an accident.

To seek possible improvement on the above shortcoming, the present inventor has come up with the present invention based on continued research and experiments for the development of the innovated structure of anti-piercing and anti-explosion vehicle tire.

To seek more advanced structural design, the present inventor has made comprehensive analysis of the previously disclosed inventions in order to seek necessary improvement and enhancement. After repeated experiments and studies, the present inventor has come up with a design for simplified assemblies, reduced costs and easy assembly to benefit the public's traffic safety.

1. For full understanding of the structure, objectives, approaches and spirit of the present invention, please refer to the following drawings and description.

### SUMMARY OF THE INVENTION

The present invention of vehicle tire with an innovated anti-piercing and anti-explosion structure (Refer to FIGS. 1 and 2) has a ring-shaped bracket device 1000 fastened onto a wheel rim 2, comprising: (Please refer to FIGS. 1, 2, 2A and 3) a specified number of arched bracket units 10 each is provided on their front and rear with a jut 101, a recess 102 and shaft holes 101a, 102a, the juts 101 and recesses 102 of respective bracket units 10 are fastened to each other, the shaft holes 101a 102a are correspondingly joined by bolts, the front and tail are serially connected with bracket fastening units 10a, 10b, using their juts 101 and recesses 102 to join with each other, a snap ring unit 104 is fastened to a hook unit 105a of a nut 105, using a bolt to fasten and form a ring-shaped bracket device 1000, on the arched surface of the bracket unit 10 and the fastening bracket units 10a, 10b is a fastening surface 103 (refer to FIG. 5), the fastening surface 103 serving to accommodate close contact with different types of wheel rims 2; wherein clamped between the fastening surface 103 of the ring-shaped bracket device 1000 and the wheel rim 2 is a pad unit 40 (FIGS. 1 and 4A) to enhance the fastening force and absorb vibration.

Wherein (FIG. 4), the structures of the bracket fastening units 10a, 10b and the bracket unit 10 are the same, except that one structure has a nut 105 protruded on one side of the shaft hole 102a, the nut 105 having a hook part 105a; while the other structure has a snap ring unit 104 and a pair of ears 104a provided with insert holes on one side of the jut 101.

Furthermore, the above bolts can be fastened by pins or bolt glue or other fixing bolts to prevent loosening.

### BRIEF DESCRIPTION OF THE DRAWINGS

FIG. 1 is an exploded view of the present invention

FIG. 2 is a perspective view of the invention with a ring-shaped bracket device assembled to a wheel rim.

FIG. 2A is a blowup view of the invention with two bracket fastener units fastened onto the ring-shaped bracket device.

FIG. 3 shows perspective views of the bracket fastener units as viewed from different angles.

FIG. 4 is a perspective view showing the two bracket fastener units of the invention.

FIG. 4A is a perspective view of the invention of pad unit.

FIG. 5 shows perspective views of a fastening surface of the ring-shaped bracket device assembled to different types of wheel rims.

FIG. 6 is a perspective section view of the invention of an innovated structure of anti-piercing and anti-explosion tire.

FIG. 7 is a perspective view of the invention of an innovated structure of anti-piercing and anti-explosion tire.

FIG. 8 is a simple section view of the invention of an innovated structure of anti-piercing and anti-explosion tire in its performance of supporting a traveling vehicle body.

### DETAILED DESCRIPTION OF THE PREFERRED EMBODIMENT

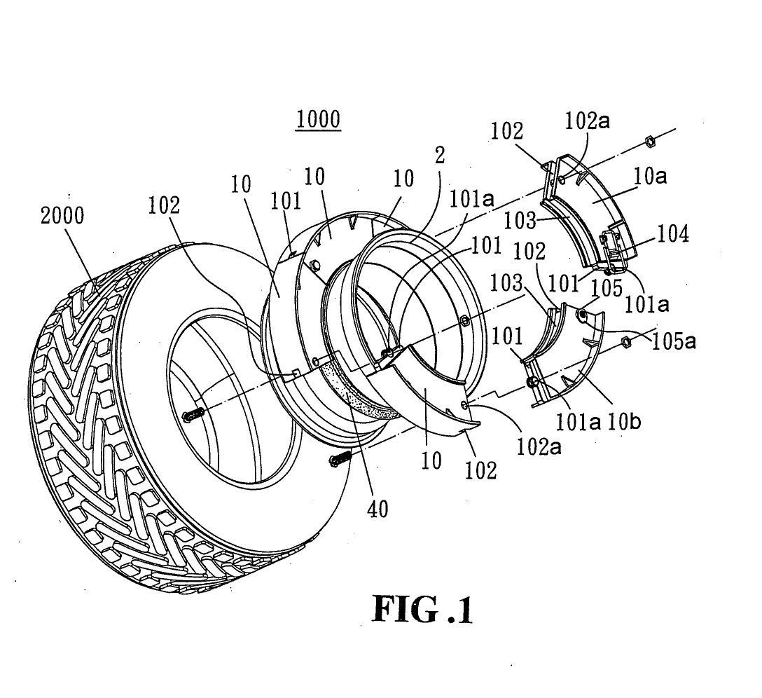

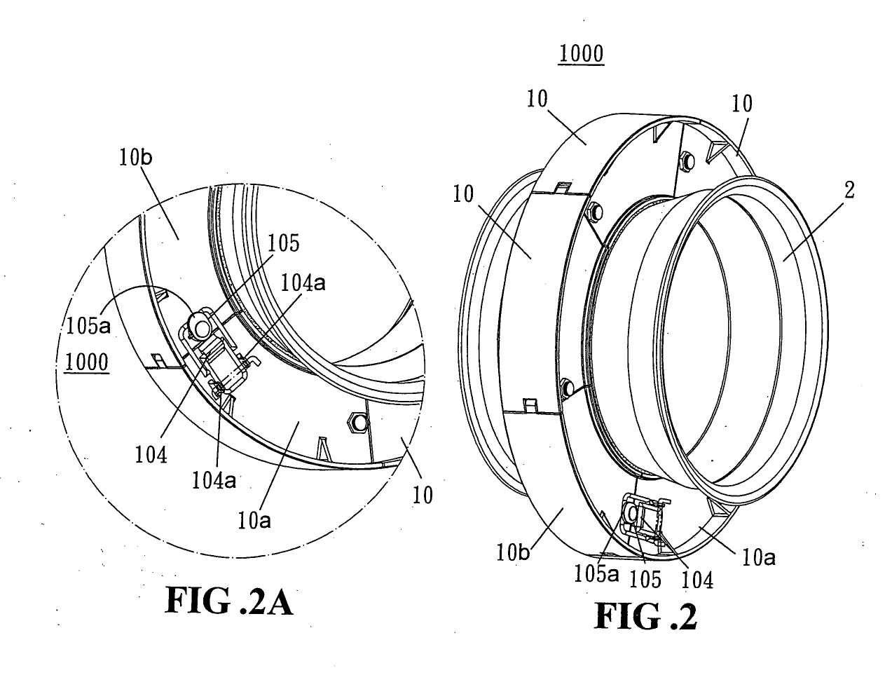

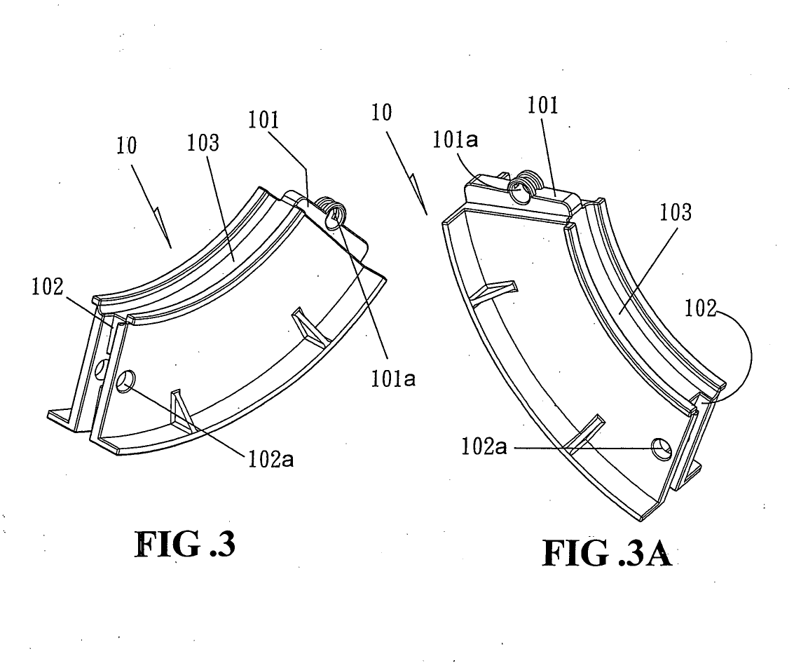

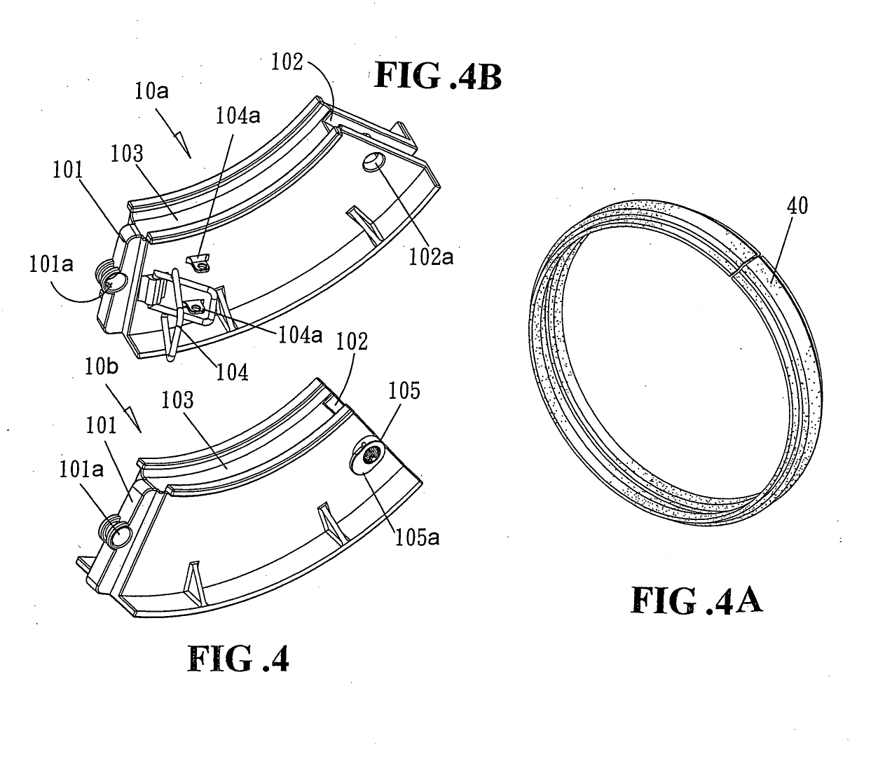

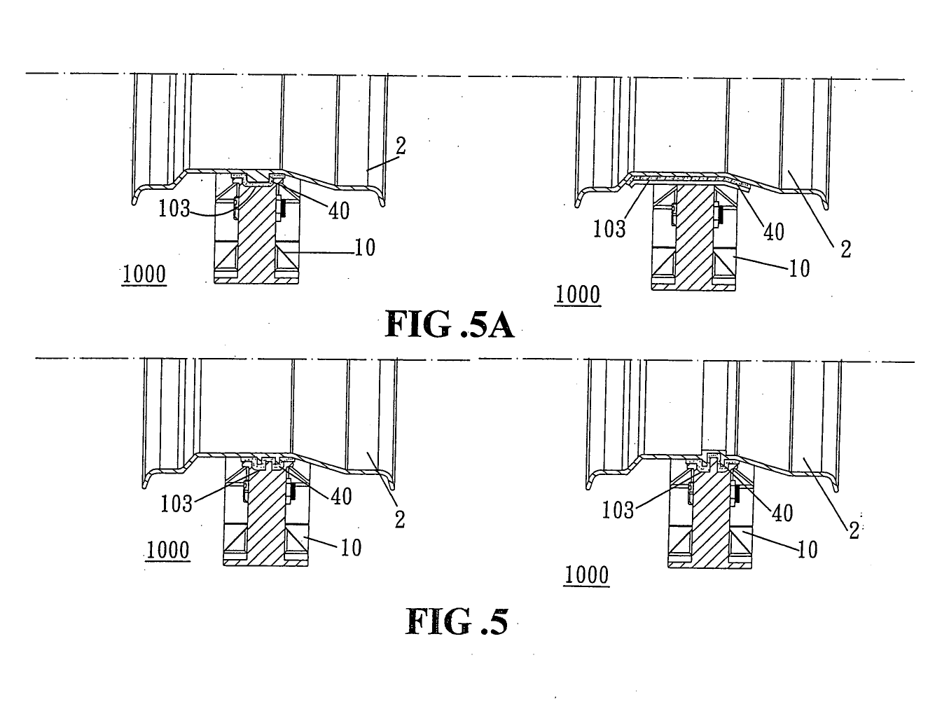

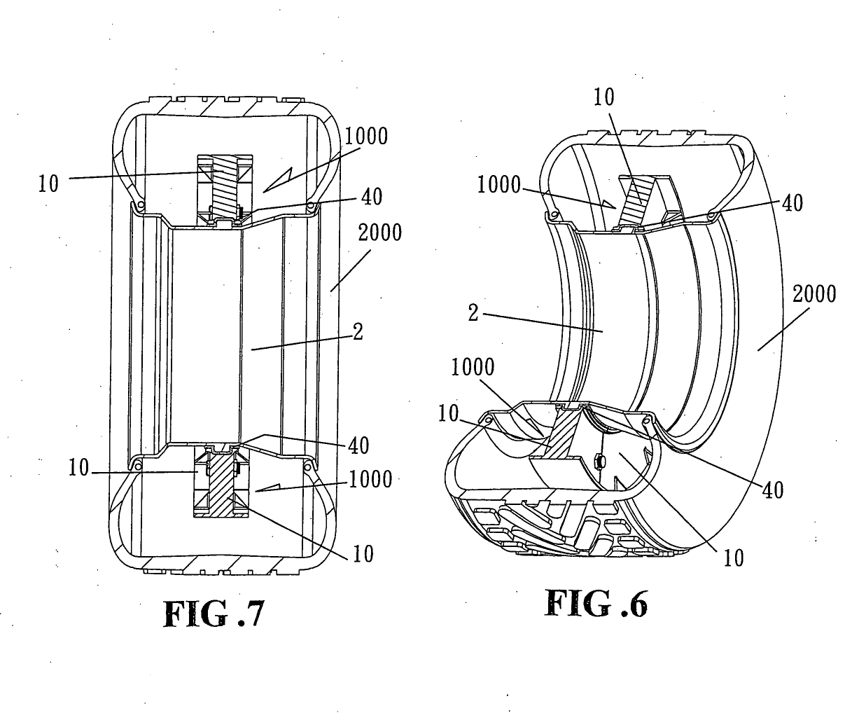

FIG. 1 shows an exploded view of the present invention, wherein a vehicle tire 2000 is joined with one side of a wheel rim 2 having a pad unit 40 fastened to its inside surface, the opening on the other side not yet joined permits accommodation of a specified number of bracket units 10 and bracket fastening units 10a, 10b that are joined by bolts, its fastening surface 10 serving to join and fasten to the wheel rim 2 (referring to FIGS. 2, 3 and 4) by inserting the juts 101 to the recesses 102 located at two ends of the bracket unit 10, with shaft holes 101a, 102a matching each other and joined by bolts, at the head and tail are bracket fastening units 10a, 10b having juts 101 and recesses 102 for joining purposes, then, fastening ring unit 104 is joined with hook parts 105a of nuts 105, and fastened by bolts to form a ring-shaped bracket device 1000, then the tire 2000 and the wheel rim 2 are completely assembled to constitute a safe tire (referring to FIGS. 6 and 7).

Optionally, the ring-shaped bracket device 1000 is formed by joining and fastening a specified number of bracket units 10 with bolts.

FIG. 2A shows a blowup of the present invention of ring-shaped bracket device with two bracket units fastened together. As shown, the fastening ring unit 104 of the bracket fastening unit 10a of the ring-shaped bracket device 1000 is hooked onto the hook part 105a of the bracket fastening unit 10b, and a pin is inserted into the insert hole of the ear 104a to prevent the fastening ring unit 104 from loosening, thereby the two bracket fastening units 10a, 10b can be pulled together, and the shaft hole 101a is brought in line with the hole of the nut 105 and fastened by a bolt.

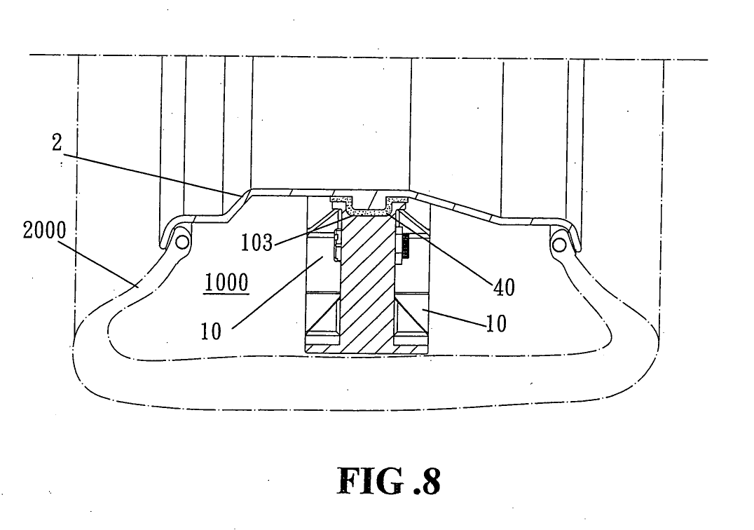

As shown in FIG. 8, in case the vehicle tire 2000 is destroyed, the ring-shaped bracket device can still support the vehicle body and the vehicle still go to a servicing garage for repair, thereby eliminating the trouble of pushing or towing the vehicle, and ensuring safety.

As seen above, the present invention is capable of anti-piercing and anti-explosion performance, and can be assembled quickly to ensure driving safety, and since it is not yet disclosed for public use and has satisfied the requirement for applicability and novelty, this application is duly filed. Your favorable consideration shall be appreciated.

Importantly, the above description covers only the preferred embodiments of the present invention, and it shall be understood that any modification or variation of performance deriving from the concept of the present invention within the scope and intent covered by the subject specifications and drawings shall be included in the subject claim.

What is claimed is:

1. An innovated structure of anti-piercing and anti-explosion wheel rim for a vehicle tire, having a ring-shaped bracket device fastened to a wheel rim, comprising a specified number of arched bracket units having juts and recesses and shaft holes on a front and back part thereof, the juts and recesses of respective bracket units being joined to each other, the shaft holes corresponding to each other and joined by bolts, provided on the front and tail of the connection being bracket fastening units joined by juts and recesses, with a fastening ring unit fastened to a hook part of a nut, and fastened by bolt to form a ring-shaped bracket device, on the arched surface of the bracket unit and the bracket fastening unit being a fastening surface, serving to accommodate close contact with different shapes of different types of wheels; wherein, clamped between the fastening surface of the bracket device and the wheel rim is a pad unit to enhance joining force and absorb shock impact;
Wherein, the structures of the bracket fastening units and the bracket units are the same, except that one of them has a nut protruded on one side of the shaft hole, the nut having a hook part; the other has a fastening ring unit and a pair of ears with insert holes on one joining side;
Thereby, a vehicle tire is joined with one side of the wheel rim where a pad unit on its inside ring surface, while other side not yet joined has an opening to accommodate a specified number of bracket units and bracket fastening units and joined with bolts, its fastening surface serving for joining and fastening with the wheel rim, with juts and recesses joined to each other on two ends of the bracket units, the shaft holes being aligned to match each other and joined by bolts, a joined head and tail being joined with bracket fastening unit that are joined by juts and recesses, then the fastening ring unit is fastened to a hook part of the nut, and fastened by bolts to form a ring-shaped bracket device, then the tire and the wheel rim are assembled completely to constitute a safe vehicle tire.

2. The innovated structure of anti-piercing and anti-explosion vehicle tire as of claim 1, wherein the fastening ring unit of the bracket fastening unit of the ring-shaped bracket device is hooked and fastened onto the hook part of the bracket fastening unit, with a pin inserting into an insert hole of the ear to prevent the fastening ring unit from loosening, thereby pulling two bracket fastening units together, with its shaft hole in line with a screw hole of a nut and fastened by a bolt.

3. The innovated structure of anti-piercing and anti-explosion vehicle tire as of claim 1, wherein the ring-shaped bracket device is formed by joining and fastening a specified number of bracket units with bolts.
